(19) United States
(12) Patent Application Publication
(10) Pub. No.: US 2021/0113016 A1
(43) Pub. Date: Apr. 22, 2021

(54) Removable Auger Assembly

(71) Applicant: Dansons US, LLC, Phoenix, AZ (US)

(72) Inventor: Jay Dean, Tempe, AZ (US)

(73) Assignee: Dansons US, LLC, Phoenix, AZ (US)

(21) Appl. No.: 16/660,121

(22) Filed: Oct. 22, 2019

(51) Int. Cl. A47J 37/07; F24B 13/04; A23B 4/052

(52) U.S. Cl. CPC A47J 37/0704; A23V 2002/00; A23B 4/052; F24B 13/04

(57) ABSTRACT

Disclosed is a cooking appliance with a removable auger assembly that directs fuel to a heat source of the appliance. For example, the auger assembly conveys fuel from a hopper to the heat source of the appliance. The auger assembly can be removed without the use of tools.

### TECHNICAL FIELD OF THE INVENTION

The presently disclosed embodiments relate generally to grills and smokers. More particularly, the presently disclosed embodiments relate to a removable auger for grills and smokers.

### BACKGROUND OF THE INVENTION

Smokers are a common outdoor cooking appliance that burn fuel at a low temperature to cause smoke to flow into a cook chamber. The smoke not only cooks the meat within the cook chamber but also provides flavor during the cooking process. Grills can use a similar process to burn fuel, typically at higher temperatures, to likewise provide a flavor to the food that is difficult to obtain using a conventional indoor cooking appliance.

Pellet grills and smokers are common types of appliances used for cooking meat or other food. These appliances burn fuel, such as pellets of wood that are supplied by an auger based on a temperature of the cook chamber. A user can operate a controller to set the temperature of the cook chamber and the auger will supply fuel to be burned until the temperature is reached. Thereafter, the appliance will sense that the desired temperature has been reached and will temporarily halt the supply of pellets by the auger to avoid going above the desired temperature, similar to a thermostat system.

When pellets are exposed to moisture, the pellets tend to stick together and jam the auger. In addition, ash and debris from burning of the pellets accumulate around the auger. Accordingly, the auger needs to be cleaned of this debris or it will jam and later malfunction.

Typical cleaning methods involve removing a hinged panel to reach inside the auger and clean with a tool such as a brush. More extensive cleaning can be performed by removing the auger itself, but this potentially requires the removal of one or more of panels, an auger motor, and possibly the controller, all while using tools that may not be accessible at the time.

### SUMMARY OF THE INVENTION

The presently disclosed embodiments include an appliance with an auger adapted to supply pellets to a heat source, such as a burn pot assembly. The auger can be removed by user-operating grips on a fastener to unthread the auger from the remainder of the appliance. The auger can further include an electrical connector that removably mates with an electrical connector in the appliance. In some embodiments, the motor can be a part of the unit that is removed with the auger to allow easier servicing of the motor. The removable auger assembly therefore allows for easier removal of the auger for cleaning and/or maintenance compared to current solutions.

In particular, the presently disclosed embodiments include an appliance. The appliance includes a hopper adapted to hold fuel, a heat source adapted to burn the fuel, and an auger assembly releasably coupled to the appliance via fasteners adapted to releasably couple to corresponding apertures disposed on the appliance. The auger assembly is adapted to convey the fuel from the hopper to the heat source. The fasteners include a grip portion.

The presently disclosed embodiments further include an auger assembly. The auger assembly includes a body adapted to releasably couple to an appliance via fasteners that releasably couple to corresponding apertures disposed on the appliance. The fasteners include a grip portion. The auger assembly further includes an auger coupled to the body. The auger is adapted to convey fuel from a hopper adapted to hold the fuel to a heat source adapted to burn the fuel.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective front view of an appliance and an auger assembly according to at least one of the presently disclosed embodiments.

FIG. 2 is a partial broken perspective front view of the appliance and the auger assembly according to at least one of the presently disclosed embodiments.

FIG. 3 is a partial broken, detail perspective bottom view of the appliance and the auger assembly according to at least one of the presently disclosed embodiments.

FIG. 4 is a partial broken perspective top view of the appliance coupled with the auger assembly according to at least one of the presently disclosed embodiments.

FIG. 5 is a perspective front view of the auger assembly according to at least one of the presently disclosed embodiments.

FIG. 6 is partial broken perspective front view of the appliance coupled with the auger assembly according to at least one of the presently disclosed embodiments.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The presently disclosed embodiments include a cooking appliance such as a smoker or grill with an auger assembly. The auger assembly is removable from the cooking appliance for cleaning and/or maintenance of the auger assembly and/or the appliance. The auger assembly can be removed without the use of tools, such as a screwdriver or drill, and can electronically connect to the remainder of the appliance using electrical connectors on both the appliance and the assembly that removably connect to one another.

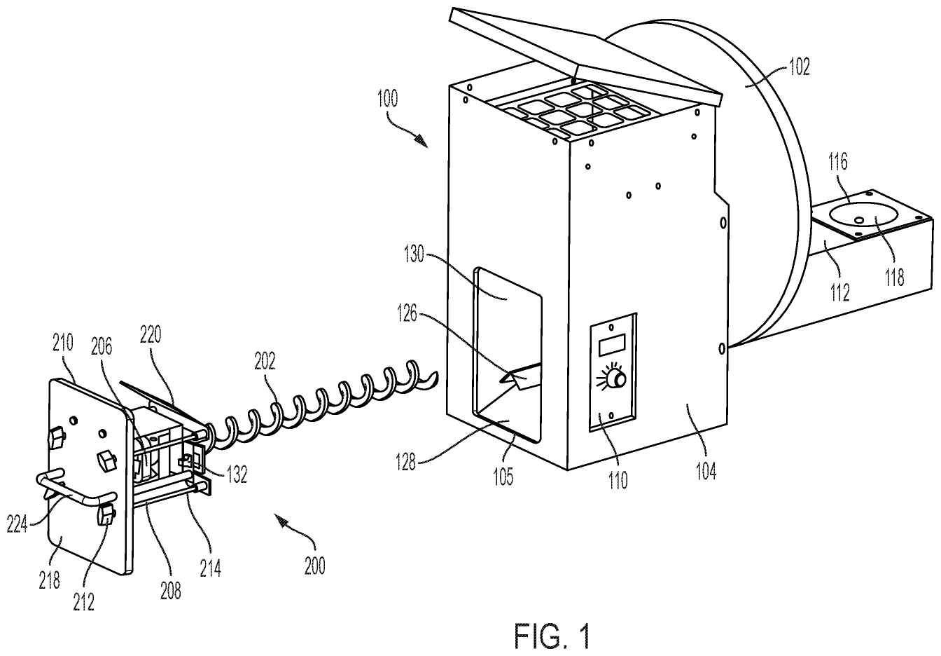

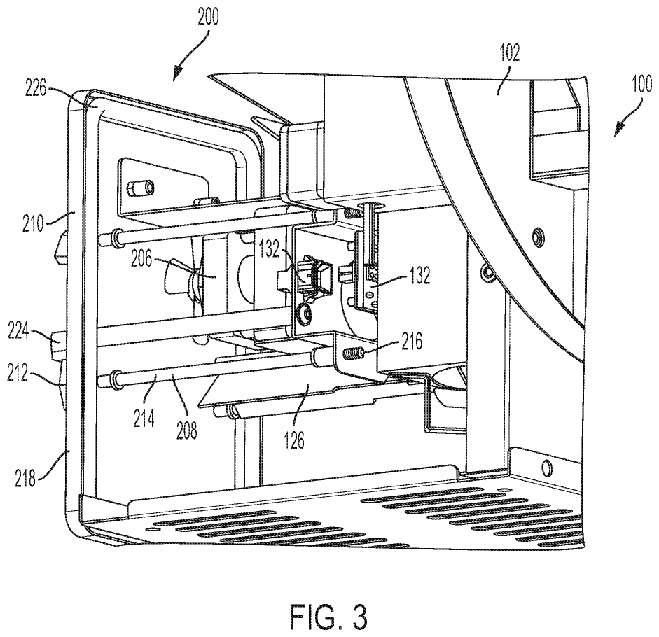

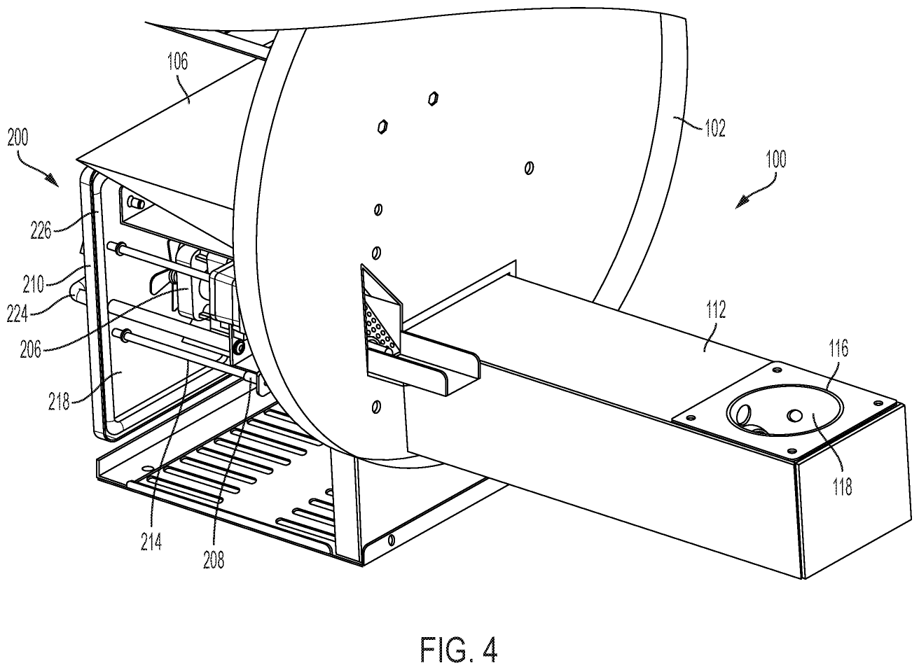

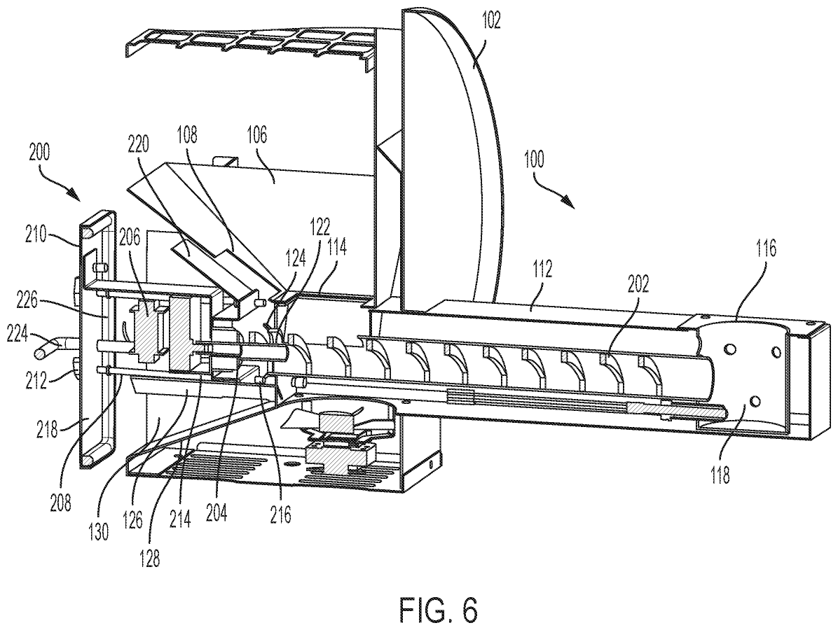

Referring to FIGS. 1-6, an appliance 100 includes a side plate 102. The side plate 102 can be part of a body, such as a barrel, that forms a cook chamber where food, for example, meat or vegetables, can be cooked in either a grilling or smoking application. The side plate 102 can be coupled to a housing 104 that is adapted to cover various components of the appliance 100 and an auger assembly 200. The housing 104 can include a housing aperture 105 adapted to allow for pellet clear out and is sized to receive the auger assembly 200.

In certain exemplary embodiments, the appliance 100 is a pellet grill or smoker, although the present invention is not so limited. As shown, the appliance 100 can include a hopper 106 on a side of the appliance 100 such that the hopper 106 abuts the side plate 102 and is disposed within the housing 104. The hopper is adapted to receive fuel, such as pellets for operation in the pellet grill or smoker. The hopper 106 can be a double taper hopper. The hopper 106 can include an aperture 108, also referred to as a clear out aperture, adapted to allow material disposed in the hopper 106 to be removed by flowing therefrom.

The appliance 100 can include a controller 110. The controller 110 can be disposed on the housing 106 or other suitable location on the appliance 100. The temperature inside the cooking chamber can be adjusted and controlled by a controller 110 based on inputs received from a user to control the internal temperature of the cooking chamber. For example, a user can use the controller 110 to set the cooking chamber to a temperature of 225 degrees, and the appliance 100 will burn fuel supplied by the auger assembly 200 until the temperature reaches 225 degrees based on a temperature sensor located within the cooking chamber. Once the temperature reaches 225 degrees, the controller 110 will control the appliance to reduce or eliminate the supply of heat temporarily. For example, and without limitation, the controller 110 can decrease the heat provided by preventing the supply of fuel to a heat source by the auger assembly 200, as described below in more detail.

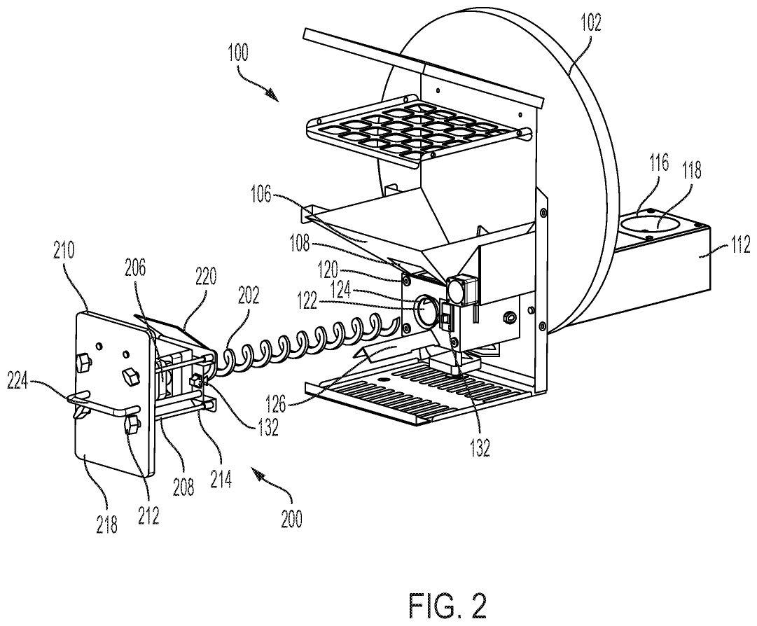

FIGS. 2-4 and 6 are partial broken views of the appliance 100. For example, FIGS. 2-4 and 6 are similar to that of FIG. 1 but with some panels of the housing 104 removed so as to expose a fuel supply system of the appliance 100. As shown, the appliance 100 can include an auger housing 112 including an inlet 114 and outlet 116. A heat source 118, such as a burn pot, can be disposed proximate the outlet 116. The inlet 114 is adapted to receive fuel, such as pellets, from the hopper 106. The auger assembly 200 can therefore direct the fuel from the inlet 114 to the heat source 118. As the fuel is heated by the heat source 118, heat and smoke is directed out of the outlet 116 and into the cooking chamber.

The auger housing 112 can include apertures 120 adapted to couple with fasteners to couple the auger assembly 200 to the appliance 100. For example, the apertures 120 can be threadably coupled with the fasteners. As illustrated, the apertures 120 can be disposed on a side of the auger housing 112 proximate the inlet 114.

The auger housing 112 can include alignment features to assist in aligning the auger assembly 200 with an auger receiving aperture 122 and the apertures 120. The auger receiving aperture 122 can include a flared circumferential rim 124. The flared circumferential rim 124 aides in aligning the auger assembly 200 with the auger receiving aperture 122. Additionally or alternately, the auger receiving aperture 122 can also include a guide 126. The guide 126 can be v-shaped, although other suitable shapes can also be used.

The appliance 100 can further include a chute 128 disposed below the clear out aperture 108 and that abuts the auger housing 112. The chute 128 is adapted to guide material out of the housing aperture 105 from the hopper 106. The chute 128 is disposed in the housing 104 and can be removable therefrom via the housing aperture 105. The chute 128 can include side walls 130.

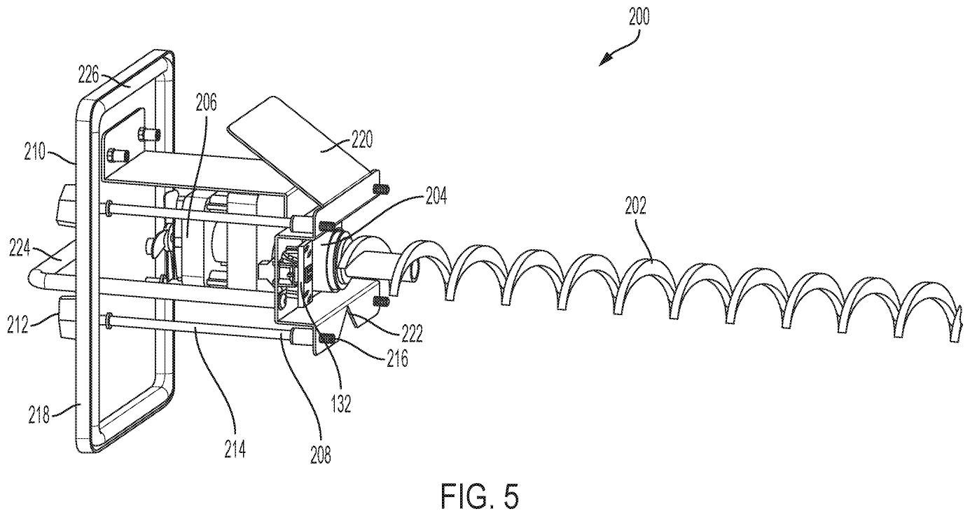

FIG. 5 is a front perspective view of the auger assembly 200 according to at least one of the presently disclosed embodiments. As shown, the auger assembly 200 can include an auger 202, a bushing 204, a motor 206, and one or more fasteners 208. The auger 202, the fasteners 208, the bushing 204, and the motor 206 are coupled to a body 210. As described herein, the auger assembly 200 is adapted to releasably couple with the appliance 100. The auger assembly 200 can be coupled or decoupled to the appliance 100 without using tools, such as a screw driver or drill. For example, as discussed below, the auger assembly 200 can be removed by rotating grip portions of fasteners located on the auger assembly to thereby decouple the fasteners from corresponding apertures located within the appliance 100.

The auger 202 is adapted to provide fuel to the heat source 118 for combustion by conveying the fuel, such as pellets, received in the inlet 114 of the auger housing 112 from the hopper 106 to the heat source 118. The auger 202 can be a helical screw blade or other suitable shape for conveying.

The fasteners 208 are adapted to threadably couple with the corresponding apertures 120 in the auger housing 112. The fasteners 208 can be coupled to the body 210 such that the fasteners 208 can be rotated relative to the body 210. The fasteners 208 can be fixed in an axial direction relative to the body 210, such that the fasteners 208 are “captured”. The fasteners 208 can include a grip portion 212, a shank portion 214, and a threaded portion 216. Rotation of the grip portion 212 causes the threaded portion 216 to threadably couple with or decouple from the corresponding apertures 120. The grip portion 212 can be adapted to be rotated without the use of tools, such as a screwdriver or drill.

The bushing 204 is adapted to couple to the body 210 and engage the auger receiving aperture 122. The bushing 204 limits contact between the auger 202 and the auger receiving aperture 122, thereby preventing or limiting premature wear of the auger 202.

The motor 206 is adapted to rotate the auger 202. The motor 206 can be controlled by the controller 110. The motor 206 can be an electric motor, where power is supplied by a power source via a power outlet or battery, or other suitable motor type. The auger assembly 200 or the appliance 100 can include a cord (not shown) adapted to be connected to the power outlet or can include the battery adapted to supply the motor 206 with power. When the cord or battery is disposed on the appliance 100, an electrical connector 132 is used to operably couple the motor 206 to the power source. The electrical connector 132 can be a tapered electrical connector, for example a Molex tapered electrical connector, where a first portion of the electrical connector 132 is coupled to the auger assembly 200, for example the body 210, and a corresponding second portion of the electrical connector is coupled to the appliance 100, for example the auger housing 112, where the first and second portions are releasably coupled to one another.

The body 210 is adapted to hold the components of the auger assembly 200 and be coupled to the appliance 100. The body 210 can include a cover plate 218 and a stop plate 220. The body 210 can include a notch 222 adapted to slidably engage with the guide 126. The notch 222 can be a v-shaped notch or other suitable shape that corresponds to the shape of the guide 126.

The cover plate 218 is adapted to cover the housing aperture 105. Although shown as having a substantially rectangular shape, the cover plate 218 can be any desired shape, such as a square, circle, etc. A seal 226, for example a silicone rubber seal, can be coupled to the cover plate 218 such that a seal is formed between the cover plate 218 and the hosing 104 when the auger assembly 200 is coupled to the appliance 100. The cover plate 218 can also include a handle 224.

The stop plate 220 is adapted to material, such as fuel, from flowing out of the clear out aperture 108 of the hopper 106. The stop plate 220 is sized to correspond with the clear out aperture 108. Although shown as having a substantially rectangular shape, the stop plate 220 can be any desired shape, such as a square, circle, etc., to correspond with a shape of the clear out aperture 108. When the auger assembly 200 is decoupled from the appliance 100, the clear out aperture 108 is no longer covered by the stop plate 220. Accordingly, material disposed in the hopper 106 is able to be removed for cleaning and/or maintenance.

As used herein, the terms “grill” or “smoker” are intended to be construed broadly as including any outdoor cooking appliance that uses heat. For example, a “grill” or “smoker” according to the present invention can include a grill, smoker, griddle, burner, wood stove, outdoor heater, or any other outdoor cooking appliance that uses heat.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. An appliance comprising:
a hopper adapted to hold fuel;
a heat source adapted to burn the fuel;
an auger assembly releasably coupled to the appliance via fasteners adapted to releasably couple to corresponding apertures disposed on the appliance, the auger assembly adapted to convey the fuel from the hopper to the heat source,
wherein the fasteners include a grip portion.

2. The appliance of claim 1, wherein the auger assembly further includes a handle.

3. The appliance of claim 1, wherein the hopper includes a clear out aperture.

4. The appliance of claim 3, wherein the auger assembly includes a stop plate adapted to restrict the fuel from flowing out of the clear out aperture.

5. The appliance of claim 1, further comprising a guide adapted to slidably engage the auger assembly.

6. The appliance of claim 5, wherein the guide is v-shaped.

7. The appliance of claim 1, wherein the auger assembly includes a motor adapted to rotate an auger and is releasably coupled to the appliance via the fasteners.

8. The appliance of claim 7, further comprising an electrical connector adapted to operably connect a power source to the motor, the electrical connector having first and second portions that are releasably coupled to each other, wherein the first portion is coupled to the auger assembly, and the second portion is coupled to the appliance.

9. The appliance of claim 1, wherein the appliance is a pellet smoker or grill.

10. The appliance of claim 1, further comprising a housing, wherein the auger assembly forms a seal with the housing when the auger assembly is coupled to the appliance.

11. The appliance of claim 1, wherein the fasteners are captured to the auger assembly.

12. An auger assembly comprising:
a body adapted to releasably couple to an appliance via fasteners that releasably couple to corresponding apertures disposed on the appliance, the fasteners including a grip portion;
an auger coupled to the body, wherein the auger is adapted to convey fuel from a hopper adapted to hold the fuel to a heat source adapted to burn the fuel.

13. The auger assembly of claim 12, wherein the fasteners are captured to the body.

14. The auger assembly of claim 13, wherein the threaded fastener is adapted to releasably couple the body to the appliance by rotation of the grip portion without using a tool.

15. The auger assembly of claim 12, further comprising a cover plate adapted to cover an aperture in a housing of the appliance.

16. The auger assembly of claim 15, further comprising a seal coupled to the cover plate and adapted to be disposed between the cover plate and the housing when the auger assembly is coupled to the appliance.

17. The auger assembly of claim 12, further comprising:
a motor coupled to the body; and
an electrical connector with first and second portions releasably coupled to each other and adapted to operably couple the motor to a power source, wherein a first portion is disposed on the auger assembly and the second portion is disposed on the appliance.

18. The auger assembly of claim 12, further comprising a bushing disposed between the auger and the body.

19. The auger assembly of claim 12, wherein the body includes a notch adapted to slidably engage a guide disposed on the appliance.

20. The auger assembly of claim 19, wherein the notch and the guide are v-shaped.
